(19) United States
(12) Patent Application Publication
(10) Pub. No.: US 2018/0339554 A1
(43) Pub. Date: Nov. 29, 2018

(54) CAP PLY STRIP WITH DIFFERENT NYLON 6,6 CONSTRUCTIONS

(71) Applicant: KORDSA TEKNIK TEKSTIL ANONIM SIRKETI, Izmit (TR)

(72) Inventor: Mehmet Sadettin FIDAN, Istanbul (TR)

(73) Assignee: KORDSA TEKNIK TEKSTIL ANONIM SIRKETI, Izmit (TR)

(21) Appl. No.: 15/739,772

(22) PCT Filed: Oct. 13, 2016
(86) PCT No.: PCT/TR2016/050383

§ 371 Date: Dec. 25, 2017

(51) Int. Cl. B60C 9/00; D02G 3/48

(52) U.S. Cl. CPC B60C 9/005; B60C 2009/2029; B60C 2009/0092; D02G 3/48

(57) ABSTRACT

The present invention relates to a novel tire cord fabric or strip made of alternating nylon cords having different constructions. Such a novel cord fabrics or strips improves high speed durability and tread separation resistance when used as zero degree spirally wound cap ply on the belt package in pneumatic radial tires.

### CROSS REFERENCE TO RELATED APPLICATIONS

This application is the national phase entry of International Application No. PCT/TR2016/050383, filed on Oct. 13, 2016, the entire contents of which are incorporated herein by reference.

### TECHNICAL FIELD OF THE INVENTION

The present invention relates to a novel tire cord fabric or strip made of alternating nylon cords having different constructions. Such a novel cord fabrics or strips improves high speed durability and tread separation resistance when used as zero degree spirally wound cap ply on the belt package in pneumatic radial tires.

### BACKGROUND OF THE INVENTION

Under high speed conditions, the outer diameter of the tire increases due to centrifugal forces generated by heavy steel cord belt package and tread. Such a diameter increase or tire growth increases the pantographic movements of the belt edge cords leading to the crack initiations, crack propagations and at the end belt edge separations.

On the other hand, the temperature rise at belt edges under high speed conditions might cause local adhesion degradation of the textile cap ply strip and leads to local cap ply tread separations which may result in belt edge separations subsequently in a short time due to non-uniform stress distributions.

The cap ply layer wound on belt package circumferentially prevent excessive tire growth under high speed conditions by applying compressive forces (restraining force) on heavy belt package made of cross ply steel cord layers. In order to enhance the restraining force, high cord count (epdm) cap ply strips are usually used (e.g. Nylon, 1400×2, 110 epdm or Nylon 1400×1, 140 epdm etc.).

Currently, most widely used cap ply materials are multi-ply nylon 6.6 layers or single layer hybrid cords (e.g. aramidinylon hybrid cords) which are spirally wound on belt package at 0 to 5 degrees to equatorial plane of the tire.

Nylon cords have excellent fatigue resistance under bending and axial compression, and bielastic tensile characteristic enabling easy processing during tire building. Additionally, shrink force generation with increasing service temperature under high speed conditions improves belt edge separation resistance and high speed durability.

It is well known the hybrid cords comprising high and low modulus yarns having bi-elastic tensile behaviour are also used as cap ply in high speed tires. The low modulus component of hybrid cord enables easy belt package lifting without excessive tight cord formation due to its high extensibility and the high modulus component becomes effective in service conditions. By using hybrid cords as cap ply, the total thickness of the cap ply layer and rubber content can be decreased, and the high modulus component of the hybrid cord improves the restraining force and high speed durability.

U.S. Pat. No. 4,284,117 describes a nylon cap ply which is formed from single yarns rather than cords. The cap ply is thinner than conventional cap plies having superior flexibility and heat dissipation characteristics.

U.S. Pat. No. 5,115,853 a radial tire having a cap ply structure disposed radially outwardly of the belt reinforcing structure. The cap ply structure comprises side by side nylon cords of 420×2 having cord twist of not greater than 280 tpm.

US Patent No. 2006/0237113 describes a zero degree belt reinforcing layer made of the alternately disposed at least one first elongated element is a hybrid cord including at least one high-elastic modulus filament and at least one low-elastic modulus filament twisted together. An elastic modulus of the at least one second elongated element is lower than an elastic modulus of the at least first elongated element.

U.S. Pat. No. 6,799,618 describes a textile cap ply structure which is superimposed radially outwardly to the belt assembly is reinforced with cords being made of materials including nylon and aramid. At initial elongation of the cords, the primary load bearing yarns are nylon yarns, and after appreciable elongation the primary load bearing yarns are the aramid yarns.

### SUMMARY OF THE INVENTION

The present invention relates to a novel tire cord fabric or strip comprising alternate nylon 6.6 cords having different constructions, namely first cords having two or three-ply constructions and second ones as single ply twisted yarns. Such a cord fabric strip combines the high impact energy absorption properties of two or three ply cords, and higher initial modulus of single ply twisted nylon 6,6 yarns.

Such a novel tire cord fabrics or strips improve high speed durability tread separation resistance and impact resistance when used as zero degree spirally wound cap ply on the belt package in pneumatic radial tires.

As well known, nylon 6.6 has excellent fatigue resistance and bi-elastic tensile behaviour which makes the lifting process possible without forming excessive tight cords, and provides sufficient restraining force under high speed conditions. But due to low initial modulus of nylon 6.6 cord, it is necessary to use high epdm (ends per decimeter) fabrics or strips as cap ply to reach the sufficient restraining force on the belt package (FIG. 1).

On the other hand, the cord-to-cord distance (rivet area) in such fabrics or strips are too narrow which makes the rubber penetration difficult between the cords without scorch.

Additionally, the rubber cracks can easily initiate between the cords having narrow rivet under dynamic conditions due to high shear stresses.

According to the invention, the nylon 6.6 cords with different constructions in cap ply strips have different modulus (or LASE), and different thermal shrink force values.

During lifting (expansion) in the curing process, single ply twisted nylon 6.6 yarns (high modulus, low extensible) are loaded much higher than that of the high twisted two or three ply cords (low modulus, high extensible cords). In addition to higher cord tensions, the low twist single ply twisted nylon 6,6 yarns under higher loading generate higher thermal shrink force (contraction force) at curing temperature. As a result of higher cord loading and higher thermal shrink force, the single ply twisted nylon 6,6 yarns penetrate the skim compound more than the two or three ply twisted cords.

As a result of penetration difference (H) of single ply twisted yarns and two or three ply twisted cords in skim compound, the mono-ply cap strip layer becomes partially two-layer (wavy) cap strip. (FIG. 2)

### Definitions

Cord: The reinforcement element formed by twisting together two or more plied yarns.

Denialer: The gramm weight of yarn having 9,000 meter length.

Dtex: The gramm weight of yarn having 10,000 meter length.

LASE: Load At Specified Load in load elongation curve

7% LASE: Load At 7% Elongation

Linear density: Weight per unit length as g/dtex or g/d (denier)

Restraining force: Force applied by cap ply on belt package during driving to prevent tire growth

Total linear density: The sum of the nominal linear densities of the ply yarns of the cord

Two-ply cord: Cord prepared by twisting together two plied yarns

Three-ply cord: Cord prepared by twisting together three plied yarns

Twist: Number of turns per meter (t/m or tpm)

Twist factor unit: tpm.dtex½

Warp: The set of yarn or cord in all woven fabrics, that runs lengthwise and parallel to the selvage and is interwoven with the filling.

### BRIEF DESCRIPTION OF THE DRAWINGS

FIG. 1 is a cross-sectional view of conventional (prior art) nylon cap ply on cross-ply steel cord belt package after curing process.

a is cross ply steel cord belt package
b is conventional cap ply on belt package
c is tread

FIG. 2 is a cross-sectional view of nylon cap ply according to invention on cross-ply steel cord belt package after curing process.

a is cross ply steel cord belt package
b is cap ply on belt package according to invention
c is tread

FIG. 3 is a cross-sectional view of nylon cap ply cord and yarn arrangements according to invention on cross-ply steel cord belt package, (1) before curing process,

(2) after curing process
A: Two-ply nylon 6.6 cord with higher twist factor, lower modulus and higher extensibility
B: Single ply twisted nylon 6.6 yarn with lower twist factor, higher modulus and lower extensibility
H: Penetration difference of A and B in rubber matrix

FIG. 4 shows the cord-to-cord distance (rivet area, spacing) changes after curing process.

(1) before curing process, (2) after curing process

S1: Cord-to-cord distance between A and B before process expansion and curing.

S2: Cord-to-cord distance between A and B after process expansion and curing

S3: Cord-to-cord distance between A and A after process expansion and curing

S4: Cord-to-cord distance between B and B after process expansion and curing

FIGS. 5 and 6 are similar to FIGS. 3 and 4 but with lower dtex single ply twisted nylon 6,6 yarns

(1) before curing process. (2) after curing process

FIG. 7 shows 1+2+1 cap ply cord and yarn arrangements.

(1) before curing process, (2) after curing process
(1)— A+B+B+A+B+B+A+ . . . cord arrangement before process expansion and curing
(2)— A+B+B+A+B+B+A+ . . . cord arrangement after process expansion and curing

FIG. 8 shows 2+1+2 cap ply cord and yarn arrangements.

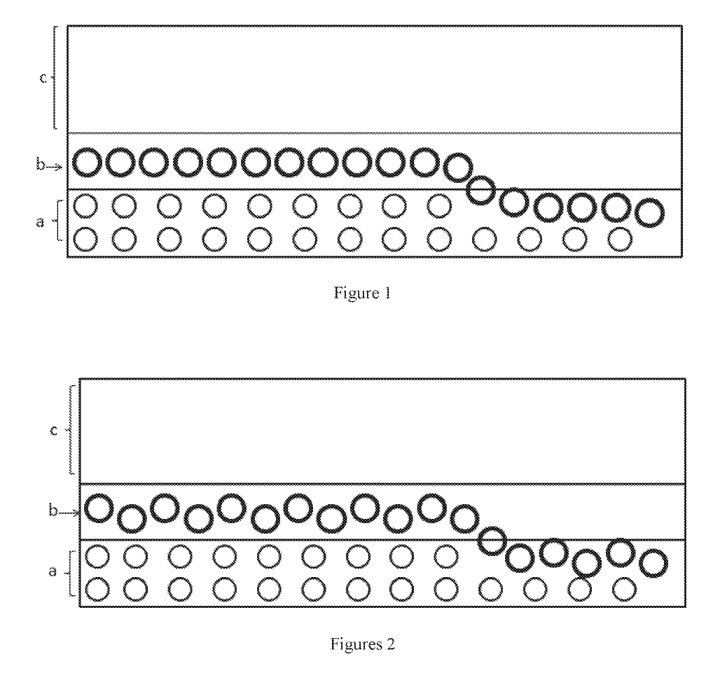

(1) before curing process, (2) after curing process
(1)— A+A+B+A+A+B+A+A+ . . . cord arrangement before process expansion and curing
(2)— A+A+B+A+A+B+A+A+ . . . cord arrangement after process expansion and curing

### DETAILED DESCRIPTION OF THE INVENTION

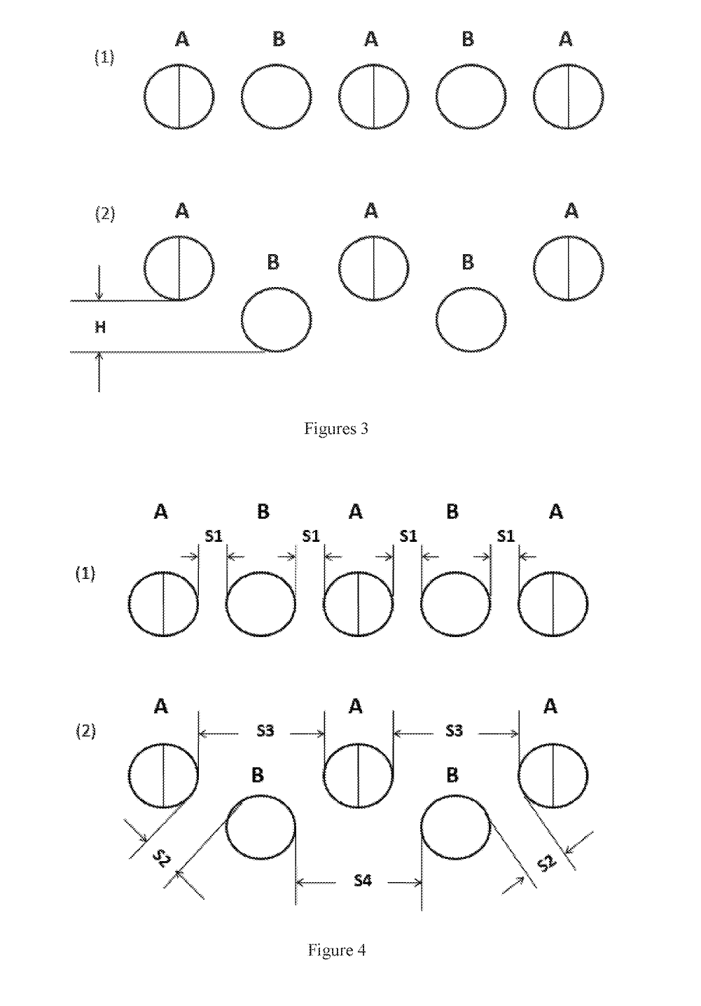

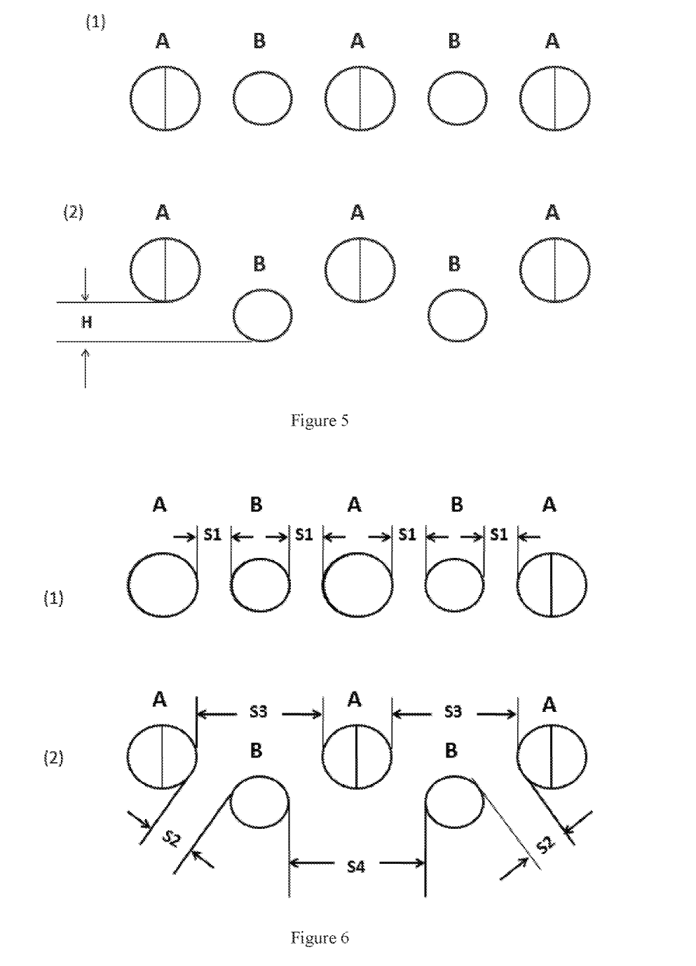

According to invention, the spirally wound cap ply fabrics or cap ply strips on belt package of the pneumatic radial tires in circumferential direction, having alternate nylon 6.6 cords and nylon 6,6 single ply twisted yarns as warp;
improves the high speed durability due to high average strip modulus, and increased cord-to-cord and yarn-to-yarn distances (less shear stresses) because of yarn shiftings in vertical direction (two layer or zig-zag formation, FIGS. 3, 4, 5 and 6).
improves the impact resistance of belt package due to higher energy absorption of high twist, and high extensible nylon cords (upper level cords are more responsive to the impacts, and lower level cords are more responsive to the tire growth).
and also improves the tread-cap ply separation resistance due to the wavy surface structure of the cap ply. The zig-zag surface enhances also mechanical bonding between cap ply and tread compound.

The nylon 6,6 cords have two or three-ply cord constructions. The alternately disposed yarns are single ply twisted yarns.

The angle of spirally wound cap ply strips to circumferential center line (or equatorial plane of the tire) is 0 to 50°.

In order to obtain the advantages mentioned above, the twist factor of nylon 6,6 cords determined according to the formula (1a) given below is minimum 10,000 and maximum 15,000.

Twist factor=Cord twist (tpm)×(total linear density of cord as dtex)^{1/2} (1a)

According to the similar formula given below (1b), the twist factor of the single ply twisted yarn is minimum 5,000 and maximum 8,000.

Twist factor=Ply twist of yarn (tpm)×(linear density of yarn as dtex)^{1/2} (1b)

According to the invention, the twist factor of the single twisted nylon 6,6 yarn is at least 5,000 unit less than the twist factor of the cord in the same cap ply strip (e.g. 1400×2, 250/250 tpm, and 1400×1, 180 tpm).

If the twist factor difference is less 5,000 unit, the wavy cap ply surface can not be created on the belt package of the tire.

According to the invention the total linear density of the cord is minimum 700 dtex and maximum 5,000 dtex, and the linear of the single ply twisted yarn is minimum 350 dtex and maximum 3,000 dtex. Those linear density limits prevent excessive rubber cuttings and too high rubber gauges. Excessive rubber cuttings may lead to the contact of cap ply cords and yarns with steel cords of belt layer and abrasion-induced breakages. Too high rubber gauge in crown area cause high heat buildup and increased rolling resistance.

The linear density of the single ply twisted yarn maximum 50% less than the total linear density of the cord.

According to the invention, the sequence of the cords and the yarns which are parallel to each other in a cap ply strip is in an alternating form as; A+B+A+B+A+B+ . . . and so on, wherein A is two or three ply nylon 6,6 cord, and B is single ply twisted nylon 6,6 yarn (FIGS. 3, 4, 5 and 6). Such a cap ply strip creates a uniform wavy surface after curing process, which bonds to tread compound strongly improving tread separation resistance under high speed conditions.

According to the invention, the sequence of the cords and the yarns which are parallel to each other in a cap ply strip is in an alternating form as follows A+B+B+A+B+B+A+B+B+ . . . and so on, wherein A is two or three ply nylon 6,6 cord, and B is the single ply twisted nylon 6,6 yarn (FIG. 7).

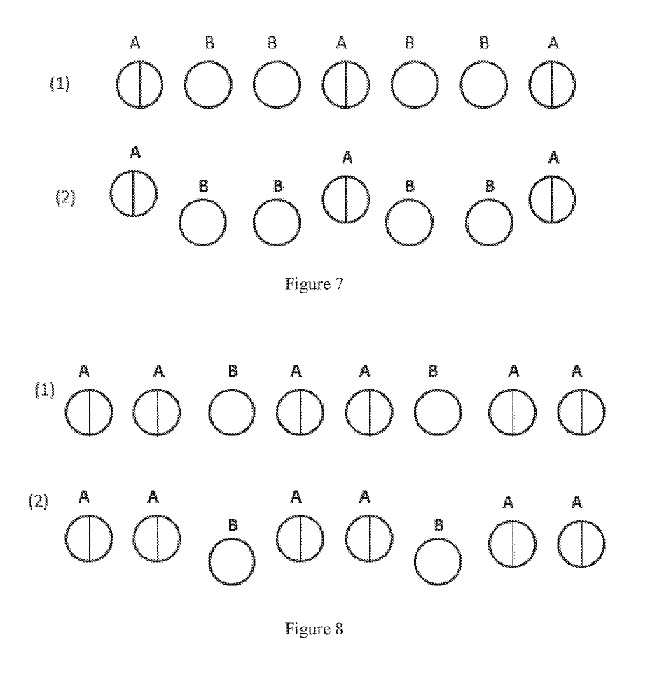

According to the invention, the sequence of the cords and yarns which are parallel to each other in a cap ply strip is in a alternating form as follows A+A+B+A+A+B+A+A+B+ . . . and so on, wherein A is two or three ply nylon 6,6 cord, and B is single ply twisted nylon 6,6 yarn (FIG. 8).

According to the invention, the cord count in strip is minimum 70 epdm (ends per decimeter). In case of cord counts lower than 70 epdm, the effectiveness of surface waviness is not enough for mechanical bonding to tread.

According to the invention, the width of the cap ply strips is 8 to 25 mm, preferably 10 to 15 mm.

1. A cap ply strip comprising:
alternately woven nylon 6.6 cords and single ply twisted nylon 6,6 yarns circumferentially wound on a belt package of a pneumatic radial tire;
wherein a twist factor of the nylon 6,6 cords, determined according to the following formula
Twist factor=Cord twist (tpm)×(total linear density of cord as dtex)^{1/2},
is at least 10,000 and maximum 15,000; and
a twist factor of the single ply twisted nylon 6,6 yarn is at least 5,000 unit less than the twist factor of the nylon 6,6 cord.

2. The cap ply strip according to claim 1, wherein the nylon 6,6 cords are two-ply cords.

3. The cap ply strip according to claim 1, wherein the nylon 6,6 cords are three-ply cords.

4. The cap ply strip according to claim 1, wherein the twist factor of the single ply twisted nylon 6,6 yarn, determined according to the following formula
Twist factor=Ply twist of yarn (tpm)×(linear density of yarn as dtex)^{1/2},
is minimum 5,000 and maximum 8,000.

5. The cap ply strip according to claim 1, wherein a linear density of the nylon 6,6 cords is minimum 700 dtex and maximum 5,000 dtex.

6. The cap ply strip according to claim 1, wherein a linear density of the single ply twisted nylon 6,6 yarns is minimum 350 dtex and maximum 3,000 dtex.

7. The cap ply strip according to claim 1, wherein a linear density of the single ply twisted nylon 6,6 yarn is not less than 50% of a total linear density of the nylon 6,6 cord.

8. The cap ply strip according to claim 1, wherein the nylon 6,6 cords and the single ply twisted nylon 6,6 yarns are arranged alternatively in the cap ply strip such that each nylon 6.6 cord is followed by one single ply twisted nylon 6.6 yarn.

9. The cap ply strip according to claim 1, wherein the nylon 6,6 cords and the single ply twisted nylon 6,6 yarns are arranged in a repeated pattern where one nylon 6,6 cord is followed by two single ply twisted nylon 6,6 yarns in the cap ply strip.

10. The cap ply strip according to claim 1, wherein the nylon 6,6 cords and the single ply twisted nylon 6,6 yarns are arranged in a repeated pattern where two nylon 6,6 cords are followed by one ply twisted nylon 6,6 yarn in the cap ply strip.

11. The cap ply strip according to claim 1, wherein a cord count in the cap ply strip is minimum 70 epdm (ends per decimeter).

12. The cap ply strip according to claim 1, wherein a width of the cap ply strip is minimum 8 mm and maximum 25 mm.

13. The cap ply strip according to claim 1, wherein a width of the cap ply strip is minimum 10 mm and maximum 15 mm.
